(19) United States
(12) Patent Application Publication
(10) Pub. No.: US 2016/0313697 A1
(43) Pub. Date: Oct. 27, 2016

(54) DISPLAY APPARATUS TO PRODUCE A 3D HOLOGRAPHIC IMAGE WITHOUT GLASSES

(71) Applicants: Roger R.Y. FORD, Beverly Hills, CA (US); Yuri Valentine ROSTOVTSEV, Denton, TX (US)

(72) Inventors: Roger R.Y. FORD, Beverly Hills, CA (US); Yuri Valentine ROSTOVTSEV, Denton, TX (US)

(21) Appl. No.: 15/134,458

(22) Filed: Apr. 21, 2016

Related U.S. Application Data
(60) Provisional application No. 62/151,057, filed on Apr. 22, 2015.

(51) Int. Cl. G03H 1/22; G09G 3/20; G09G 3/02; G09G 3/00; G09G 5/10

(52) U.S. Cl. CPC G03H 1/22; G09G 3/003; G09G 5/10; G09G 3/02; G09G 3/2092

(57) ABSTRACT

A display apparatus for producing a three-dimensional holographic image of an object. An array of coherent laser-diode light sources is configured to produce a three-dimensional holographic image of the object. An external laser is connected to the array for injecting optical radiation into the laser-diode light sources to control the phase thereof based on image data of the object.

This application claims the priority of Provisional Patent Application No. 62/151,057 filed on Apr. 22, 2015 and entitled DISPLAY APPARATUS TO PRODUCE A 3D HOLOGRAPHIC IMAGE WITHOUT GLASSES.

### BACKGROUND OF THE INVENTION

1. Field of the Invention

The present application relates to a three-dimensional holographic display device.

2. Description of Background Art

Holographic displays are used to display objects in three dimensions. Typically, a three-dimensional image requires a medium (e.g., spinning mirrors) onto which the image is projected. However, conventional holographic imaging devices are not compact and are not capable of providing a holographic display without reflective media.

### BRIEF SUMMARY OF THE INVENTION

Presently disclosed embodiments represent a display apparatus configured to produce a three-dimensional holographic image. An array of coherent light laser-diode sources can produce the image, based on obtained image data.

One embodiment is directed to a method for producing a three-dimensional holographic image. The method includes the technique to synchronize the operation of the array of laser diodes by injection of coherent radiation of a master laser and control the phases of the injected radiation by phase controllers.

### BRIEF DESCRIPTION OF THE DRAWINGS

FIG. 1A is a schematic view illustrating a principle of the imaging.

FIG. 1B is a schematic view illustrating that if one can reproduce the same radiation fields their amplitudes and phases, the Observers see the full three-dimensional holographic image, which will be no difference from the Objects.

FIG. 2 is a schematic view of the display apparatus that creates the full three-dimensional holographic image, according to the disclosed embodiment.

### DETAILED DESCRIPTION OF THE INVENTION

In the following description of embodiments, reference is made to the accompanying drawings which form a part hereof, and in which it is shown by way of illustration specific embodiments in which the invention can be implemented. It is to be understood that other embodiments can be used and structural changes can be made without departing from the scope of the disclosed embodiments.

The present invention relates to a display apparatus configured to produce a three-dimensional holographic image. A coherent laser-diode light source can produce the based on obtained image data of an object to display.

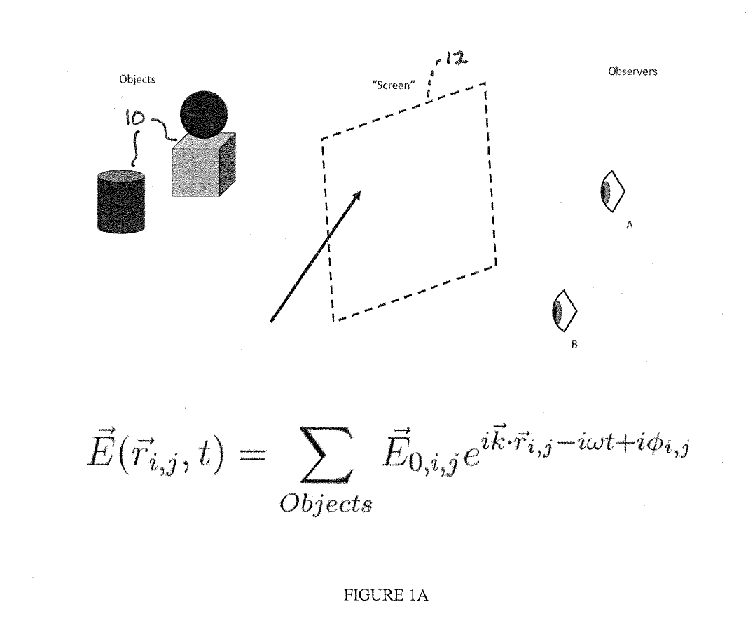

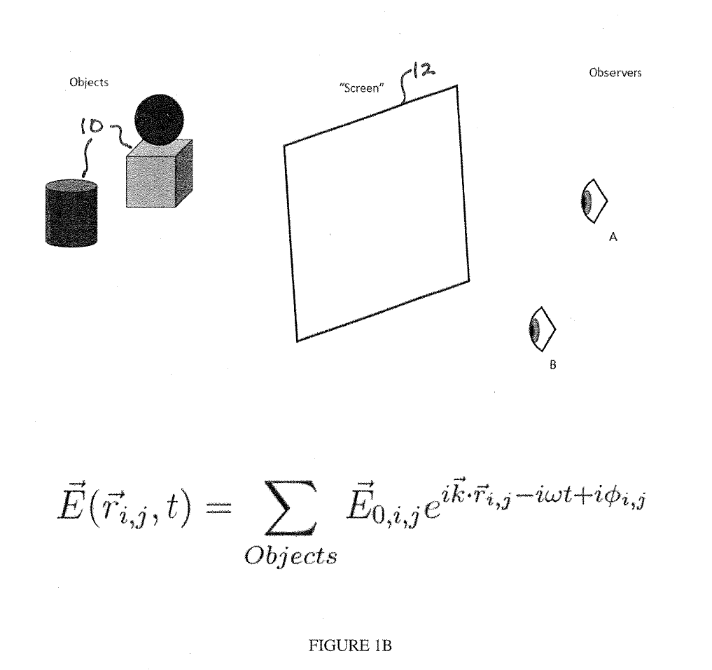

FIG. 1A illustrates a principle of the imaging. The objects 10, which are shown in the FIG. 1A, can be viewed by the Observers A and B. The imaginary “Screen” 12 has the radiation fields that have amplitudes and phases distribution along itself. The field created in the Screen plane is given by:

$$\vec{E} ( {\vec{r}}_{i , j} , t ) = {\sum }_{Objects} {\vec{E}}_{0 , i , j} {e}^{i \vec{k} \cdot {\vec{r}}_{i , j} - i ω t + i {φ}_{i , j}}$$

The Observers A and B can see the objects 10 and they have a full three-dimensional view. By moving their heads (eyes) they can see the images behind the objects 10. All information that Observers A and B are using to reach a full three-dimensional view can be related not to the real space of the objects 10, but rather to the radiation fields their amplitudes and phases. The distribution of the radiation does not depend on the absolute phase of radiation but rather on the relative phase, as one can see from the distribution of intensity of radiation as given by:

$${\vert \vec{E} ( {\vec{r}}_{i , j} , t ) \vert}^{2} = \sum {\sum }_{Objects} {\vert {\vec{E}}_{0 , i , j} \vert}^{2} {e}^{i \vec{k} \cdot ( {\vec{r}}_{i , j} - {\vec{r}}_{{i}^{′} , {j}^{′}} ) + i ( {φ}_{i , j} - {φ}_{{i}^{′} , {j}^{′}} )}$$

so that it depends only on phase difference (see the Equation above).

FIG. 1B illustrates that if we can reproduce the same radiation fields their amplitudes and phases, the Observers A and B see the full three-dimensional holographic image, which will be no difference from the objects 10. Using Grin function, one can write the field created by the objects at any positions as:

$$\vec{E} ( {\vec{r}}^{′} ) = \frac{1}{4 π} {\int }_{Objects} {d}^{3} r \frac{{e}^{i k \vert \vec{r} - {\vec{r}}^{′} \vert}}{\vert \vec{r} - {\vec{r}}^{′} \vert} \vec{P} ( \vec{r} ) \qquad ( EQ 1 )$$

Where polarization is excited in the objects either by external radiation or just by the internal sources. In particular the Equation above can be used to calculate the distribution of the field on the Screen 12 (See FIGS. 1A and 1B). Now, if it is assumed that the field on the Screen 12 is known, one can calculate the propagation of the field further by using Grin function as

$$\vec{E} ( \vec{r} ) = \frac{1}{4 π} {\int }_{Screen} d A \frac{{e}^{i k \vert \vec{r} - {\vec{r}}^{′} \vert}}{\vert \vec{r} - {\vec{r}}^{′} \vert} \vec{E} ( {\vec{r}}^{′} ) \qquad ( EQ 2 )$$

Here, the integration occurs over the Screen 12, and the field is given at the screen surface. This relation allows one to find out the distribution of the optical field at any given positions. The very important relation between the previous two Equations is the following. If we plug the optical field from the (EQ1) into the (EQ2), we obtain that:

$$\vec{E} ( \vec{r} ) = \frac{1}{4 π} {\int }_{Screen} d A \frac{{e}^{i k \vert \vec{r} - {\vec{r}}^{′} \vert}}{\vert \vec{r} - {\vec{r}}^{′} \vert} \vec{E} ( {\vec{r}}^{′} ) = \frac{1}{4 π} {\int }_{Objects} {d}^{3} r \frac{{e}^{i k \vert \vec{r} - {\vec{r}}^{′} \vert}}{\vert \vec{r} - {\vec{r}}^{′} \vert} \vec{P} ( \vec{r} ) \qquad$$

In other words, the field created by the Screen 12 is exactly the same as the field created by the objects 10. If we manage somehow to produce the same distribution of the optical fields on the screen with the same distribution of the relative phase, we can create the images of the objects 10. These images are holographic and they have the same appearance as the objects 10 themselves.

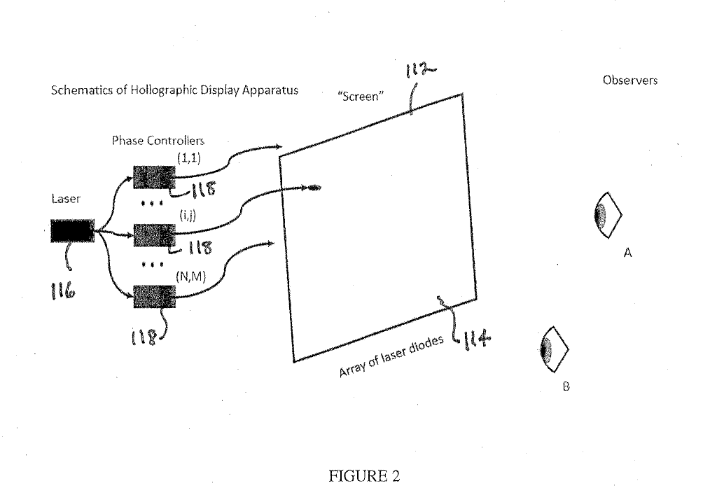

FIG. 2 shows a detailed view of schematics of the display apparatus that creates the full three-dimensional holographic image, according to the disclosed embodiment.

The screen 112 comprises an array of laser-diodes 114. The radiation of the laser diodes 114 is controlled by coupling with an external laser 116. The radiation of all elements of the array of laser-diodes 114 has a phase that is determined by the injected radiation from the external laser 116 (it can be also a laser-diode). The optical radiation from the external laser 116 is split to be injected into all array. Also before injection, the phase of the radiation can be changed by phase-controllers 118. Thus, the operation of the elements of the array depends on the driven current through the laser diodes 114 and on the optical phase of the radiation injected to start operation of the laser-diodes 114. It allows for the radiation of the laser-diodes 114 to reproduce any distribution of the intensities and phases of optical radiation across the screen 112, and thus the holographic image is created and controlled by the apparatus. The quality of the image depends on the size of the screen 112 and on the number of the elements of the array of laser diodes 114.

The device can work in the holographic regime, creating the full three-dimensional holographic image, and, in a simple regime of just a regular flat color display. The modern technology allows one to provide HD standards for the quality of image in a regular flat regime, as well as in the holographic regime. The principles of this display apparatus can be implemented and successfully used in a broad range of devices, for example, TV sets, personal computers, laptops, monitors, cellular (smart) phones, indoor and outdoor 3D lighting.

1. A display apparatus for producing a three-dimensional holographic image of an object, comprising an array of coherent laser-diode light sources configured to produce a three-dimensional holographic image of the object, an external laser connected to the array for injecting optical radiation into the laser-diode light sources to control the phase thereof based on obtained image data of the object.

2. The display apparatus of claim 1 wherein the external laser is a laser-diode.

3. The display apparatus of claim 1 wherein a phase-controller is connected to the external laser to vary the phase of the optical radiation injected into the laser-diode light sources.

4. The display apparatus of claim 3 wherein a plurality of phase-controllers is connected to the external laser.

5. The display apparatus of claim 1 wherein radiation of the laser-diode light sources reproduces a distribution of intensities and phases of optical radiation across a screen to create the holographic image.
